(19) United States
(12) Patent Application Publication
(10) Pub. No.: US 2026/0299852 A1
(43) Pub. Date: Oct. 1, 2026

(54) NON-TRANSITORY COMPUTER-READABLE STORAGE MEDIUM, CONTROL METHOD, AND ELECTRONIC APPARATUS

(71) Applicant: CANON KABUSHIKI KAISHA, Tokyo (JP)

(72) Inventor: SHU IWATA, Kanagawa (JP)

(21) Appl. No.: 19/575,340

(22) Filed: Mar. 23, 2026

(30) Foreign Application Priority Data
Mar. 25, 2025 (JP) 2025-050807

(51) Int. Cl. G06F 3/12; G06F 3/04817; G06F 3/0488

(52) U.S. Cl. CPC G06F 3/1255; G06F 3/04817; G06F 3/0488; G06F 3/1204; G06F 3/1285

(57) ABSTRACT

A storage medium storing programs that, when executed by computers operating under an operating system in which a specific function is enabled by default, the specific function causing a specific display element provided by the OS to be displayed in an end region of a display unit in a semi-transmissive manner and causing a screen provided by an application software to be displayed in an area including the end region of the display unit, cause the computers to perform operations includes displaying a screen provided by the application software, the screen including, on a side of the end region, an operation item that accepts a print instruction, transmitting a print job to a printing apparatus based on a touch operation performed on the operation item, and disabling the specific function of the OS such that the print instruction screen is displayed with the specific function disabled.

### BACKGROUND

### Field of the Technology

The present disclosure relates to a non-transitory computer-readable storage medium, a control method, and an electronic apparatus, and, more particularly, relates to a screen display technique using application software which runs on an electronic apparatus.

### Description of the Related Art

A method of screen display which effectively utilizes a limited display region is known. Japanese Patent Laid-Open No. 2005-141731 describes, as a method for efficiently performing displaying even in a portable device constrained in size, a technique of, in a virtual graffiti area which is set in a partial area of a screen, a graffiti screen image in a semitransparent manner in superimposition on a main screen image.

Moreover, in Android™ 15, which is an operating system (OS) for, for example, smartphones, Edge-to-Edge (hereinafter referred to as “E2E”) is enabled by default.

E2E is a display method of displaying a display target screen which application software (hereinafter referred to as an “app”) provides on the entire area of a display and displaying a status bar and a navigation bar which the OS provides at an upper portion and a lower portion of the display, respectively, in semi-transmissive and superimposition manners. Performing display using E2E enables displaying the display target screen, which the app provides, in larger size.

### SUMMARY

The present disclosure is directed to providing a contrivance capable of effectively preventing or reducing the operability of an operation item which application software provides from decreasing due to displaying of a display element which an operating system (OS) provides.

According to an aspect of the present disclosure, a non-transitory computer-readable storage medium storing one or more programs that, when executed by one or more computers operating under an operating system (OS) in which a specific function is enabled by default, the specific function causing a specific display element provided by the OS to be displayed in an end region of a display unit in a semi-transmissive manner and causing a screen provided by an application software to be displayed in an area including the end region of the display unit, cause the one or more computers to perform operations includes displaying, on the display unit, a print instruction screen provided by specific application software, the print instruction screen including, on a side of the end region, an operation item configured to accept a print instruction, transmitting, to a printing apparatus serving as an external device, a print job based on a touch operation performed on the operation item, and disabling the specific function of the OS such that the print instruction screen is displayed with the specific function disabled.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a data processing system according to an embodiment of the present disclosure.

FIG. 2 is a block diagram illustrating a hardware configuration of an electronic apparatus.

FIG. 3A is a software configuration diagram of a print application (print app), which runs on the electronic apparatus.

FIG. 3B is a table showing a correspondence relationship between various screens which the print app provides, layout files corresponding to the respective screens, and settings of Edge-to-Edge (E2E) defined in the respective layout files.

FIGS. 4A, 4B, 4C, 4D, 4E, and 4F are diagrams illustrating display examples of a screen which the print app provides and a screen which an operating system (OS) provides, which are displayed on a display.

FIG. 5A is a diagram illustrating a display example of an EditText element in a screen which is provided by the print app.

FIG. 5B is a diagram illustrating an example of a standard layout which is used in a case where English text is displayed in a cursive font.

FIG. 5C is a diagram illustrating an example of a layout obtained by adding a width and a padding to display English text in a cursive font.

FIG. 5D is a diagram illustrating a display example obtained in a case where a print instruction screen of the print app has been displayed in landscape layout.

FIGS. 6A and 6B are flowcharts of an operation of the print app.

FIG. 7 is a flowchart of screen display processing.

### DESCRIPTION OF THE EMBODIMENTS

Consider a case where, with regard to displaying using Edge-to-Edge (E2E), a touch operation item which application software (app) provides has been displayed at a position which overlaps with a status bar or a navigation bar. In this case, even if the user touches the touch operation item of the app for the purpose of touching that, such a touching operation may be accepted as an operation performed on the status bar or the navigation bar. Thus, it may become difficult for the user to perform the intended operation. With regard to a print app for issuing an instruction for printing to a printing apparatus, a print button, which is an operation item (display item) for issuing an instruction for printing, is especially of high importance in the print app, and the inconvenience of becoming difficult to perform the intended operation on the print button is significant. Moreover, if the operability of an operation item for establishing communication with the printing apparatus serving as an external device decreases, there occurs a cause for a state in which the user is unable to issue an instruction for printing to the printing apparatus. Accordingly, with regard to an app for transmitting an instruction to an external device, such as the print app, the inconvenience caused by the operability of an operation item for establishing communication with an external device targeted for instruction decreasing is also significant.

Therefore, in the present disclosure, a contrivance capable of effectively preventing or reducing the operability of an operation item which application software provides from decreasing due to displaying of a display element which an operating system (OS) provides is described.

Various embodiments, features, and aspects of the present disclosure will be described in detail below with reference to the drawings.

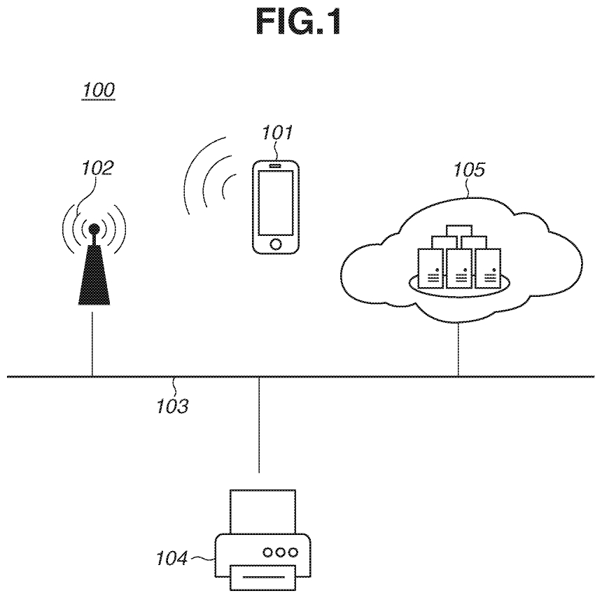

FIG. 1 is a block diagram illustrating a configuration of a data processing system according to an embodiment of the present disclosure.

The data processing system 100 includes an electronic apparatus 101, a wireless local area network (LAN) terminal 102, a printing apparatus 104, and a cloud server 105, and such various apparatuses are interconnected via a network 103.

The electronic apparatus 101 is a mobile terminal such as a smartphone, in which an operating system for small-sized terminals and a program for controlling a call and data communication run. Moreover, the electronic apparatus 101 can be a personal computer which is not equipped with, for example, voice control, position detection control, and mobile phone data communication. Moreover, the electronic apparatus 101 is connected to the network 103 by the wireless LAN terminal 102, which has the function of a wireless LAN access point.

The wireless LAN terminal 102 is a wireless LAN base unit having a general network and router function, and is providing a wireless LAN using Wi-Fi® inside, for example, a home or office. The wireless LAN terminal 102 is an access point (AP) in wireless LAN communication in infrastructure mode.

The printing apparatus 104 (an image processing apparatus or an image forming apparatus) is a digital multifunction peripheral equipped with various job execution functions such as a printer function, a copy function, a scanner function, and a facsimile transmission function, or a printer. The user is able to operate the electronic apparatus 101 to instruct the printing apparatus 104 to execute a job for, for example, printing, scanning, or facsimile.

The cloud server 105 is able to connect to the network 103 via the Internet, and performs, for example, the management of data which is used for the electronic apparatus 101 or the printing apparatus 104 and the extension processing for various functions.

The electronic apparatus 101 and the printing apparatus 104 are able to perform short-range wireless communication via a wireless signal for, for example, Near Field Communication (NFC) or Bluetooth® Low Energy (BLE). The printing apparatus 104 retains, in an NFC communication unit 210 or a BLE communication unit 211 described below, information (for example, Internet Protocol (IP) address and media access control (MAC) address) for performing wireless LAN connection with the printing apparatus 104, and the electronic apparatus 101 acquires such connection information by short-range wireless communication. Then, the electronic apparatus 101 starts communication with the printing apparatus 104 based on the acquired connection information.

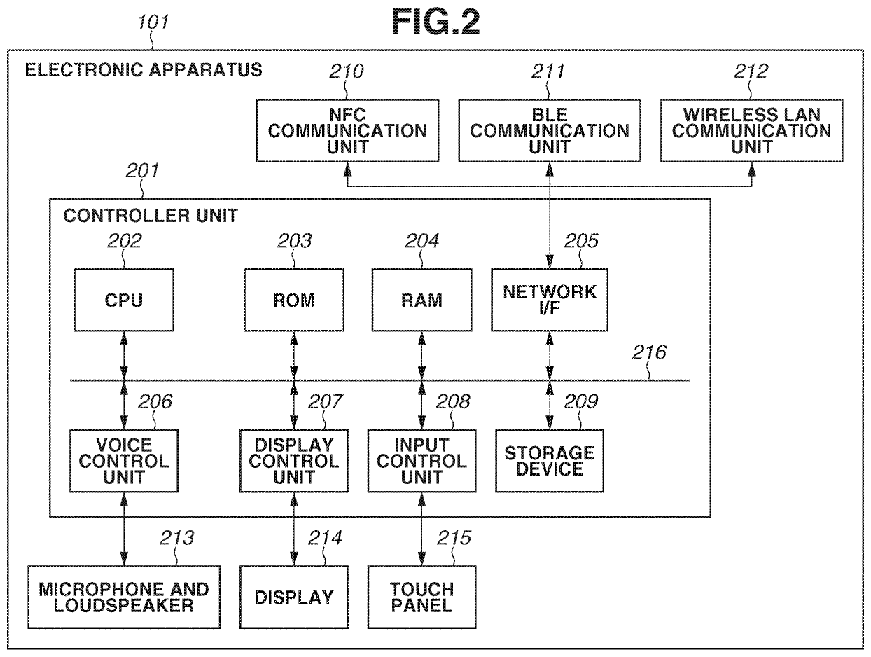

FIG. 2 is a block diagram illustrating a hardware configuration of the electronic apparatus 101. A controller unit 201 controls various communication units, such as the NFC communication unit 210, the BLE communication unit 211, and a wireless LAN communication unit 212, and various user interface (UI) units, such as a microphone and loudspeaker 213, a display 214, and a touch panel 215. Moreover, the controller unit 201 includes a central processing unit (CPU) 202, a read-only memory (ROM) 203, a random access memory (RAM)204, a network interface (I/F) 205, a voice control unit 206, a display control unit 207, an input control unit 208, and a storage device 209, and such units are interconnected by a system bus 216.

The CPU 202 includes one or more processors, and controls the entire system of the electronic apparatus 101. The ROM 203 stores an operating system (OS) of the electronic apparatus 101 and various apps such as an app for controlling call and data communication and a print app 300. Furthermore, “app” is an abbreviation for “application software”. The RAM 204 is a memory used for the CPU 202 to execute various programs, and is a work memory area used for an application to execute a program.

The storage device 209 is a non-volatile storage device (storage medium) and records therein, for example, various operation mode settings required to be retained even after restarting of the electronic apparatus 101 and running logs. The network I/F 205 is connected to the NFC communication unit 210, the BLE communication unit 211, and the wireless LAN communication unit 212, and performs various wireless communication control operations with the printing apparatus 104 and the cloud server 105.

The voice control unit 206 performs input and output control of voice data via the microphone and loudspeaker 213. The display control unit 207 performs output control of image data which is to be displayed on the display 214. The input control unit 208 performs input control of information which the user has indicated via hardware keys such as buttons or the touch panel 215. The voice control unit 206, the display control unit 207, and the input control unit 208 are used to provide various applications which are to be executed by the electronic apparatus 101 to the user.

The touch panel 215 is a touch sensor which detects various touch operations on a display surface of the display 214 (an operation surface of the touch panel 215). The touch panel 215 and the display 214 can be configured in an integrated manner. For example, the touch panel 215 is configured to have such a light transmittance as not to hinder displaying performed by the display 214, and is attached to the upper layer of the display surface of the display 214. Then, the input coordinates in the touch panel 215 are associated with the display coordinates on the display screen of the display 214. With this, a graphical user interface (GUI) can be configured as if the user were able to directly operate a screen displayed on the display 214.

The CPU 202 is able to detect the following operations performed on the touch panel 215 or states thereof:
the state in which a finger or pen, which has not been touching the touch panel 215, has newly touched the touch panel 215, in other words, starting of a touch (hereinafter referred to as “touch-down”);
the state in which a finger or pen is touching the touch panel 215 (hereinafter referred to as “touch-on”);
the state in which a finger or pen is moving while touching the touch panel 215 (hereinafter referred to as “touch-move”);
the state in which a finger or pen, which has been touching the touch panel 215, has been separated from the touch panel 215, in other words, ending of a touch (hereinafter referred to as “touch-up”); and
the state in which none is touching the touch panel 215 (hereinafter referred to as “touch-off”).

When touch-down is detected, touch-on is also detected at the same time. After touch-down, unless touch-up is detected, touch-on normally continues being detected. Touch-move is also detected in the state in which touch-on is detected. Even if touch-on is detected, unless the touch position is not moving, touch-move is not detected. After touch-up of all of the fingers or pen touching the touch panel 215 is detected, touch-off is detected. Information on these operations or states and the coordinates of a position at which a finger or pen is touching the touch panel 215 is communicated to the CPU 202 via an internal bus, and the CPU 202 determines how an operation (touch operation) has been performed on the touch panel 215 based on the communicated information. With regard to touch-move, the CPU 202 is able to also detect the direction of movement of a finger or pen moving on the touch panel 215 for each of a vertical component and a horizontal component on the touch panel 215 based on a change of the position coordinates. When it is detected that touch-move has been performed a predetermined distance or more, the CPU 202 is assumed to determine that a slide operation has been performed. An operation of quickly moving the finger a certain degree of distance while keeping the finger touching the touch panel 215 and then directly separating the finger from the touch panel 215 is referred to as “flick”. In other words, the flick is an operation of quickly tracing the surface of the touch panel 215 as if flicking the touch panel 215 with the finger. When touch-move performed a predetermined distance or more at a predetermined speed or higher is detected and touch-up is then detected, the CPU 202 determines that flick has been performed (determines that flick has been performed subsequent to a slide operation). Additionally, a touch operation of concurrently touching a plurality of positions (for example, two points) and then moving the touch positions closer to each other is referred to as “pinch-in”, and a touch operation of moving the touch positions away from each other is referred to as “pinch-out”. Pinch-out and pinch-in are collectively referred to as a “pinch operation” (or simply as “pinch”). The touch panel 215 can be any type of touch panel selected from among touch panels of various types including, for example, the resistance film type, the capacitance type, the surface acoustic wave type, the infrared ray type, the electromagnetic induction type, the image recognition type, and the optical sensor type. Among these types, there are a type which detects that touch has been performed based on contact with the touch panel and a type which detects that touch has been performed based on access of a finger or pen to the touch panel, but any one of the two types can be employed.

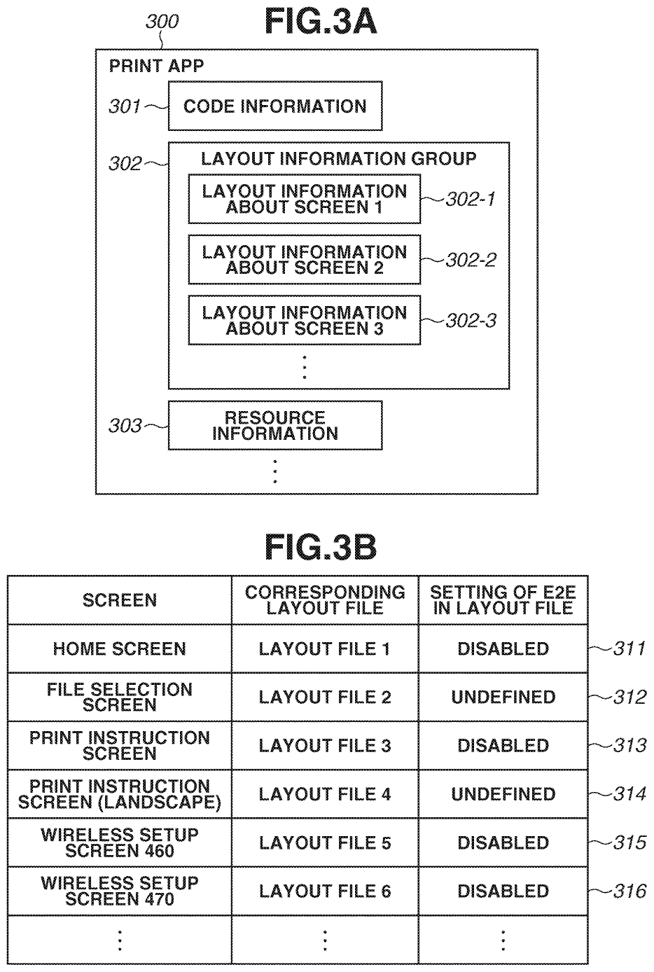

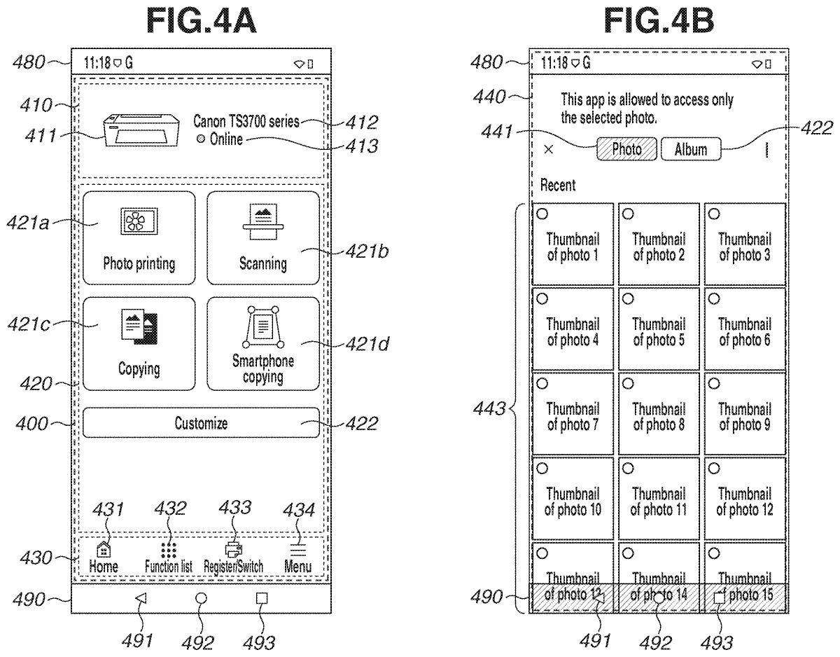

FIG. 3A is a software configuration diagram of a print app 300, which runs on the electronic apparatus 101. Information for distribution of the print app 300 stored in an app distribution server is downloaded into the electronic apparatus 101 via the Internet and is installed thereon, so that the print app 300 becomes able to run on the electronic apparatus 101. The print app 300 is software which the CPU 202 of the electronic apparatus 101 executes, and is stored in the ROM 203. The information for distribution of the print app 300 is, specifically, a software package file such as an Android™ Package Kit (APK) file. Upon the print app 300 being installed, a state in which the print app 300 has been stored with a software configuration illustrated in FIG. 3A in the ROM 203 is obtained. FIG. 3A illustrates a part of the configuration of the print app 300, so that the print app 300 also includes pieces of information other than the pieces of information illustrated in FIG. 3A.

The print app 300 includes code information 301, a layout information group 302, and resource information 303.

The code information 301 stores therein a program which is to be executed by the CPU 202.

The layout information group 302 includes pieces of layout information (layout files) for displaying various screens which the print app 300 provides. The pieces of layout information exist for the respective screens, and the stored pieces of layout information include, for example, layout information 302-1, layout information 302-2, and layout information 302-3 corresponding to respective three screens, i.e., a screen 1, a screen 2, and a screen 3. Each of the pieces of layout information is preliminarily stored as one file serving as a layout file. Each of the pieces of layout information includes information indicating whether to perform E2E in the corresponding screen and position designation information for designating the position of each screen part (for example, each of view, icon, text, and image) in a screen. Furthermore, “E2E” is an abbreviation for “ Edge-to-Edge”. The method of designating the position which is designated by the position designation information includes several methods, and, for example, there is a method of aligning a specific position of a part to be arranged (a display item) with any one of or two or more of the upper side, lower side, left side, and right side of the display area. Moreover, the method of designation also includes designating margins from the respective sides. Moreover, the method of designation also includes aligning the specific position of an item with the position of another item which is arranged in the same screen. For example, the method of designation also includes, for example, performing arrangement in such a way as to align the upper side of a part 1, which is a rectangle, with the upper side of the display area and align the left side of the part 1 with a position away from the left side of the display area by 10 margin dots (thus, at a position spaced from the left side at an interval of 10 dots). Moreover, the method of designation also includes, for example, arranging a part 2, a part 3, and a part 4 side by side with a margin of 10 dots for the respective intervals in order from the lower side of the display area and arranging the respective parts in such a manner that the center in the horizontal (left-and-right) direction of each part coincides with the center in the horizontal (left-and-right) direction of the display area.

The resource information 303 is content which is used by the print app 300, such as images and text.

FIG. 3B is a diagram illustrating a table showing a correspondence relationship between various screens which the print app 300 provides, layout files corresponding to the respective screens, and settings of E2E defined in the respective layout files.

In the table illustrated in FIG. 3B, row 311 indicates that the layout file corresponding to a home screen is a layout file 1 and, in the layout file 1, E2E is set to disabled. Row 312 indicates that the layout file corresponding to a file selection screen is a layout file 2 and, in the layout file 2, no definition about E2E is provided, i.e., E2E is undefined. Similarly, even in rows 313 to 316, correspondence relationships such as those shown in FIG. 3B are indicated. Specifically, in a case where, in each layout file, there is a description “android: fitsSystemWindows=“true””, E2E being disabled is defined. In the example illustrated in FIG. 3B, it is shown that such a description is present in the layout files 1, 3, 5, and 6. In a case where, in each layout file, there is a description “android: fitsSystemWindows=“false””, E2E being enabled is defined. Since E2E becomes enabled by default, the OS in the present embodiment does not need to particularly have such a description. In a case where, in each layout file, there is no description about “android: fitsSystemWindows”, E2E is undefined, so that whether E2E becomes enabled or becomes disabled in a corresponding screen follows the settings of the OS. In the example illustrated in FIG. 3B, E2E is undefined in the layout files 2 and 4.

Furthermore, while, in the example illustrated in FIG. 3B, an example in which row 313 indicates a print instruction screen and row 314 indicates a print instruction screen (landscape), i.e., there are two types of print instruction screens, is shown, a configuration in which the print app 300 does not have such two types and there is only one type of print instruction screen indicated in row 313 can be employed. Thus, a configuration in which, irrespective of whether the screen is in portrait orientation or in landscape orientation, one type of print instruction screen indicated in row 313 is displayed can be employed.

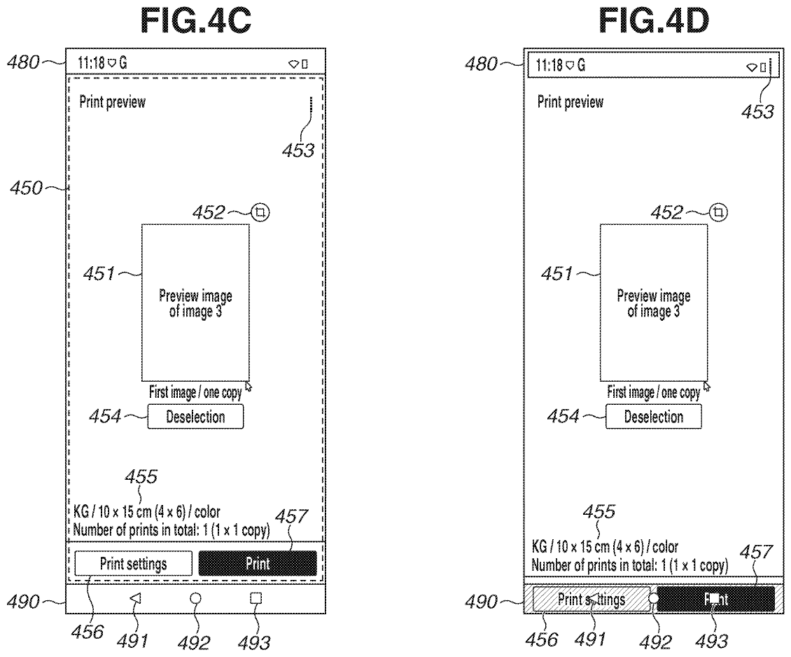

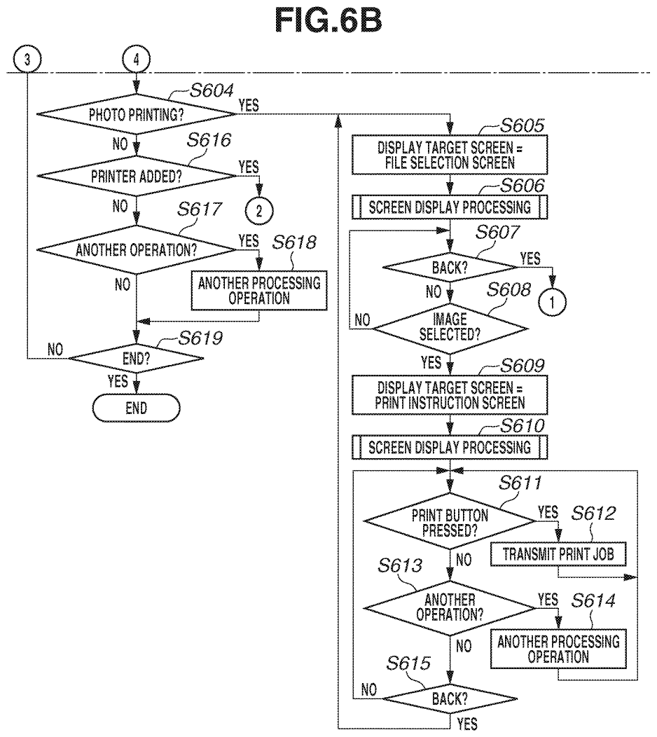

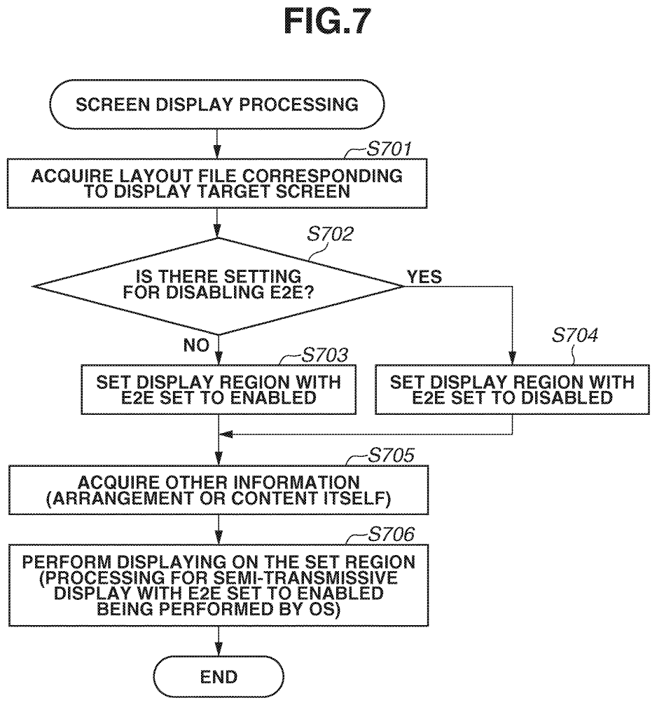

FIGS. 4A, 4B, 4C, 4D, 4E, and 4F are diagrams illustrating display examples of a screen which the print app 300 provides and a screen which the OS provides, which are displayed on the display 214. Furthermore, in the present embodiment, an example in which the electronic apparatus 101 operates according to the OS (for example, Android™ 15) in which E2E is enabled by default is described. Furthermore, as long as the OS is OS in which E2E is enabled by default, the applicable OS is not limited to Android™ 15 and can be, for example, an Android™ OS higher than Android™ 15. E2E being enabled by default is synonymous with that, if E2E is undefined in layout information in an app, an app screen corresponding to the layout information provides displaying using E2E. In FIGS. 4A to 4F, the same display elements are assigned the respective same reference characters. The details of display contents are described in the description of the flowcharts of FIGS. 6A and 6B and FIG. 7 described below.

FIGS. 6A and 6B are flowcharts of an operation of the print app 300. In response to an instruction for activating the print app 300 being issued in the electronic apparatus 101 (in response to the print app 300 being launched), processing illustrated in FIGS. 6A and 6B is started. This processing is implemented by the CPU 202 loading a program (more specifically, a program included in the code information 301) of the print app 300 recorded on the ROM 203 onto the RAM 204 and executing the program.

In step S601, the CPU 202 determines whether a printer (printing apparatus) to which a print instruction is transmittable is currently registered with the print app 300. If it is determined that such a printer is previously registered (YES in step S601), the CPU 202 advances the processing to step S602, and, if it is determined that such a printer is not currently registered (NO in step S601), the CPU 202 advances the processing to step S620.

In step S602, the CPU 202 sets a home screen as a display target screen, which is a screen to be displayed by the print app 300 (records such a screen on the RAM 204).

In step S603, the CPU 202 performs screen display processing on the screen which has been set as the display target screen. The screen display processing is described below with reference to FIG. 7. In response to the processing operation in step S603, the home screen is displayed.

FIG. 4A is a diagram illustrating a display example of the home screen 400 of the print app 300, which is displayed on the display 214. The home screen 400 is a range represented by the outermost dashed line in FIG. 4A. The home screen 400 includes a printer display region 410, a function display region 420, and a tab region 430. Frames drawn by dashed lines in FIG. 4A are illustrated only for indicating the respective display regions and are, therefore, not displayed in actuality.

In the printer display region 410, a printer icon 411, printer identification information 412, and status information 413 are displayed. The printer icon 411 is a display item, such as an image, an icon, or a picture, representing the external appearance of a printer which is a printer previously registered with the print app 300 and which is currently set as a current job execution target (hereinafter, referred to simply as a “target printer”). For example, the external appearance of the printing apparatus 104 is displayed. The printer identification information 412 is text information indicating the identifier of the target printer, with which, for example, the model number of a printer, a series name thereof, or a model name thereof is displayed. The status information 413 indicates the current state of the target printer. In the example illustrated in FIG. 4A, the status information 413 indicates that the target printer is online, i.e., in the state of being currently connected to the electronic apparatus 101 in such a way as to be able to communicate with the electronic apparatus 101.

In the function display region 420, a function icon 421 for instructing the target printer to execute the respective functions thereof is displayed. One or a plurality of function icons are collectively referred to as a “function icon 421”. The function icon 421 to be displayable can include zero to a plurality of function icons, and, in the example illustrated in FIG. 4A, four function icons, i.e., function icons 421a to 421d, are displayed in list form. The function icons 421a to 421d are icons (display items) for accepting instructions for photo printing, scanning, copying, and smartphone copying, respectively.

The photo printing is the function of transmitting an image to be printed from the electronic apparatus 101 to the target printer and causing the target printer to print the image. The scanning is the function of storing, in the electronic apparatus 101, an image obtained by the target printer performing reading. The copying is the function of printing, by the target printer, an image obtained by the target printer performing reading. The smartphone copying is the function of printing, by the target printer, an image obtained by a camera (image capturing unit) (not illustrated) of the electronic apparatus 101 performing image capturing. In response to each function icon being touched (hereinafter, also referred to as “being pressed”), the home screen transitions to a lower-level screen for issuing an instruction for executing the corresponding function. In response to an execution button being pressed in the lower-level screen, an execution instruction for the function (execution instruction for a job) is accepted, so that the job is transmitted to the target printer.

The user is able to optionally change (customize) which function icon to display in the function display region 420 or in which order to arrange the function icons in the function display region 420. A customization button 422 is an operation icon for accepting an instruction for transitioning to a customization screen for customizing the function icon 421 arranged in the function display region 420.

In the tab region 430, tab icons 431 to 434, which are operation items for accepting instructions for respective functions different from the execution instructions for a job to the target printer. The tab icon 431 is provided for accepting an instruction for transitioning to the home screen 400. The tab icon 432 is provided for accepting an instruction for displaying a function list. The tab icon 433 is provided for accepting an instruction for displaying a screen for registering a new printer with the print app 300 or switching the target printer from among a plurality of registered printers. The tab icon 434 is provided for accepting an instruction for displaying a settings menu screen of the print app 300.

A status bar 480 displayed at an upper portion of the display 214 is a display element which is provided by the OS, and is different from the screen which the print app 300 provides. In a display region of the status bar 480, for example, current time, Wi-Fi signal status, mobile phone line signal status, remaining battery amount, and simple notification from another app are displayed.

A navigation bar 490 displayed at a lower portion of the display 214 is a display element which is provided by the OS, and is different from the screen which the print app 300 provides. In a display region of the navigation bar 490, a back button 491, a home button 492, and a task button 493 are included. The back button 491 is an operation item for accepting an instruction for returning to a preceding screen. The home button 492 is an operation item for accepting an instruction for switching from a screen which the app provides to the home screen of the electronic apparatus 101. The home screen of the electronic apparatus 101, which is displayed in response to an operation on the home button 492, is a screen different from the home screen 400 of the print app 300, and is a screen in which, for example, app icons (activation icons) of a plurality of apps and a widget are displayed. The task button 493 is an operation item for accepting an instruction for switching to a task screen in which apps which are activated including another app which is running in background are displayed in list form.

In the example illustrated in FIG. 4A, the status bar 480 and the navigation bar 490, which the OS provides, are not superimposed on the home screen 400. In other words, the display region of the home screen 400 is within the range of a display surface of the display 214 excluding the status bar 480 and the navigation bar 490. As indicated in row 311 shown in FIG. 3B, E2E being set to disabled is defined in the layout file 1 corresponding to (defined in) the home screen 400. Therefore, due to the processing illustrated in FIG. 7 described below, the status bar 480 and the navigation bar 490 are not superimposed on the home screen 400. Thus, the example illustrated in FIG. 4A is an example in which the home screen 400 is displayed with E2E set to disabled. Accordingly, the display range of the home screen 400 is a range excluding the status bar 480 and the navigation bar 490 from the entire area of the display 214, and is narrower than the entire area of the displayable range of the display 214.

In step S604, the CPU 202 determines whether the function icon 421a for photo printing has been touched (pressed). If it is determined that the function icon 421a has been touched (YES in step S604), the CPU 202 advances the processing to step S605, and, if it is determined not so (NO in step S604), the CPU 202 advances the processing to step S616.

In step S605, the CPU 202 sets a file selection screen as the display target screen, which is a screen to be displayed by the print app 300 (records such a screen on the RAM 204).

In step S606, the CPU 202 performs screen display processing on the screen set as the display target screen. The screen display processing is described below with reference to FIG. 7. In response to the processing operation in step S606, the file selection screen is displayed.

FIG. 4B is a diagram illustrating a display example of the file selection screen 440, which is displayed on the display 214.

A photo icon 441 is an operation icon for selecting the selection of a file from photos (i.e., from image files). An album icon 442 is an operation icon for accepting an instruction for, after selecting an album, selecting a photo (image file). In response to the photo icon 441 being selected, in the file selection screen, a list of photos 443 is displayed, so that the CPU 202 accepts, from the user, selection of one or a plurality of photos (image files) from the list of photos 443. FIG. 4B illustrates a display example in which the photo icon 441 has been selected, and the user selects, by touching, one or a plurality of thumbnails from among a plurality of photos (image files) displayed in the list of photos 443. In response to one or a plurality of thumbnails being touched, a check mark is displayed for the touched thumbnail, so that the touched thumbnail enters into a display state indicating that the touched thumbnail has been selected. When one or more photos have been checked, a “next” button is displayed, and, in response to the “next” button being touched by the user, a print instruction screen 450 (see FIG. 4C) is displayed with the selected photo (the checked photo) set as a print target.

In the example illustrated in FIG. 4B, the status bar 480 and the navigation bar 490, which the OS provides, are superimposed on the file selection screen 440. In other words, the display region of the file selection screen 440 is within the range of a display surface of the display 214 including the status bar 480 and the navigation bar 490. As indicated in row 312 shown in FIG. 3B, the layout file 2 corresponding to (defined in) the file selection screen 440 has no description as to whether to set E2E to enabled or disabled, and is thus undefined. Accordingly, since E2E is enabled by default in the OS, due to the processing illustrated in FIG. 7 described below, the file selection screen 440 is set to be displayed in a range including the status bar 480 and the navigation bar 490.

The example illustrated in FIG. 4B is an example in which the file selection screen 440 has been displayed with E2E set to enabled, and the display range of the file selection screen 440 is the entire area of the displayable range of the display 214. With displaying being performed in this way, even in a case where there is a large number of photos to be displayed in the list of photos 443, as compared with a case where E2E has been set to disabled, it is possible to display more thumbnails of photos with use of a wider region at one time (at the same time). Specifically, since, in a case where E2E has been set to disabled, a display region for the navigation bar 490 is not used, thumbnails of photos 13 to 15 are unable to be displayed or are displayed with the lower portions thereof more dropping out than that in the example illustrated in FIG. 4B. On the other hand, since, if E2E is set to enabled, thumbnails of photos 13 to 15 are displayed also with use of the back side of the navigation bar 490 displayed in a semi-transmissive manner, the user is able to understand the contents of thumbnails of photos 13 to 15. Thus, the at-a-glance readability of the list of photos 443 improves. Moreover, in the example illustrated in FIG. 4B, the thumbnails of photos 13 to 15 have portions overlapping with the navigation bar 490 and are, therefore, somewhat difficult to be selected by touch. However, performing scrolling enables the thumbnails of photos 13 to 15 to be displayed at an upper portion of the display 214 which does not overlap with the navigation bar 490. In doing so, the thumbnails of photos 13 to 15 also become operable without interfering with the navigation bar 490.

In the case of a screen in which not only a list of photos but also a number of options not fitting into one screen are displayed also with use of a region adjacent to the lower side of the display surface of the display 214 and are displayed with scrolling, if E2E is set to enabled, there is a similar advantageous effect. In the case of such a screen, avoiding setting E2E to disabled is favorable.

In step S607, the CPU 202 determines whether the back button 491 has been touched.

If it is determined that the back button 491 has been touched (YES in step S607), the CPU 202 returns the processing to step S602, and, if it is determined not so (NO in step S607), the CPU 202 advances the processing to step S608.

In step S608, the CPU 202 determines whether image selection has been completed. If, in the file selection screen 440, one or more photos have been checked and the “next” button has been displayed and then touched by the user, the CPU 202 determines that image selection has been completed. If it is determined that image selection has been completed (YES in step S608), the CPU 202 advances the processing to step S609, and, if it is determined not so (NO in step S608), the CPU 202 returns the processing to step S607.

In step S609, the CPU 202 sets a print instruction screen as the display target screen, which is a screen to be displayed by the print app 300 (records such a screen on the RAM 204).

In step S610, the CPU 202 performs screen display processing on the screen set as the display target screen. The screen display processing is described below with reference to FIG. 7. In response to the processing operation in step S610, the print instruction screen is displayed.

FIG. 4C is a diagram illustrating a display example of the print instruction screen 450 (print preview screen), which the print app 300 provides, on the display 214. The print instruction screen 450 is a range indicated by a dashed line illustrated in FIG. 4C. A frame drawn by the dashed line in FIG. 4C is illustrated only for indicating the display region and is, therefore, not displayed in actuality. A preview image 451 is a print preview image of the image (for example, an image 3 (the thumbnail of photo 3)) selected in the file selection screen 440. Although, in the example illustrated in FIG. 4C, the preview image 451 is simply indicated by a character string, a print image is displayed in actuality. A trimming icon 452 is an operation icon for accepting an instruction for displaying a trimming screen used to issue an instruction for trimming the image 3. A menu icon 453 is an operation icon for accepting an instruction for displaying a list of options for other processing operations (a processing menu) which are acceptable in the print instruction screen 450. A deselection icon 454 is an operation icon for accepting an instruction for deselecting an image which is being displayed for preview (in the example illustrated in FIG. 4C, the image 3) and excluding the deselected image from a print target. A setting state 455 is text information indicating the current print settings. In the example illustrated in FIG. 4C, the print settings in which the print paper size is KG (postcard) size of 10 centimeters (cm)×15 cm, the setting of color or monochrome is color, and the number of prints is 1 page in total for 1 copy per one selected image are shown. A print settings button 456 is an operation icon for accepting an instruction for displaying a print settings screen. By touching the print settings button 456, the user is able to cause the print settings screen to be displayed and operate the print settings screen to change various print settings concerning the image currently selected (in the example illustrated in FIG. 4C, the image 3). For example, the user is able to change the print paper size, the setting of color or monochrome, and the number of prints. If the print settings are changed, the display content of the setting state 455 is changed in conformity with the changed settings. A print button 457 (printing button) is an operation icon for accepting an operation for issuing an instruction for printing an image which is being displayed for preview as a print target (in the example illustrated in FIG. 4C, the image 3) with the current print settings. In response to the print button 457 being touched, a print job for issuing an instruction for printing an image serving as a print target with the print settings indicated by the setting state 455 is generated, and the generated print job is transmitted from the electronic apparatus 101 to a target printer (for example, the printing apparatus 104).

In the example illustrated in FIG. 4C, the status bar 480 and the navigation bar 490, which the OS provides, are not superimposed on the print instruction screen 450. In other words, the display region of the print instruction screen 450 is within the range of a display surface of the display 214 excluding the status bar 480 and the navigation bar 490. As indicated in row 313 shown in FIG. 3B, E2E being set to disabled is defined in the layout file 3 corresponding to (defined in) the print instruction screen 450. Therefore, due to the processing illustrated in FIG. 7 described below, the status bar 480 and the navigation bar 490 are not superimposed on the print instruction screen 450. Thus, the example illustrated in FIG. 4C is an example in which the print instruction screen 450 is displayed with E2E set to disabled. Accordingly, the display range of the print instruction screen 450 is a range excluding the status bar 480 and the navigation bar 490 from the entire area of the display 214, and is narrower than the entire area of the displayable range of the display 214.

As illustrated in FIG. 4C, the print button 457 is set (defined), in the layout file 3, in such a way as to be displayed, based on a lower side of the display region of the print instruction screen 450, with a small margin set from the lower side. The margin from the lower side to the print button 457 is smaller than the width in the vertical direction (the height) of the navigation bar 490. In this way, the print button 457 is arranged at a position prominent relative to another display element located in the same screen and is arranged in such a way as to be easily operable by the hand of the user who is operating the electronic apparatus 101. Furthermore, in general, when operating a vertically oriented smartphone, the user often holds the lower part of the device with one hand, and no matter whether the user touches the screen with a finger (for example, the thumb) of the holding hand or with a finger (for example, the index finger) of the hand opposite to the holding hand, the lower part of the screen is easier to operate than the upper part thereof. Thus, the print button 457 is arranged at a position best in operability in the print instruction screen 450. The print button 457 is not allowed to be changed in position by a scrolling operation. On the other hand, if E2E is unfavorably set to enabled, as illustrated in FIG. 4D, the navigation bar 490 is unfavorably superimposed on the print button 457, so that the print button 457 may become difficult to operate. Specifically, even if the user touches the position of the print button 457 illustrated in FIG. 4D, such a touch may be recognized by the device as a touch on the navigation bar 490, so that the function of the task button 493 is executed and, therefore, it becomes impossible to issue a print instruction. Alternatively, it becomes difficult to perform an operation for a print instruction. In the print app 300 for issuing an instruction for printing to a printing apparatus, the print button 457, which is an operation item (display item) for issuing an instruction for printing, is particularly of high importance in the print app 300. Therefore, the disadvantage of making it difficult to operate the print button 457 as intended is significant. To prevent the occurrence of such a situation, in displaying the print instruction screen 450 in which the print button 457 for issuing an instruction for printing is displayed at the lower portion of the screen thereof, the present embodiment disables E2E as illustrated in FIG. 4C.

In step S611, the CPU 202 determines whether the print button 457 has been touched (pressed). If it is determined that the print button 457 has been touched (YES in step S611), the CPU 202 advances the processing to step S612, and, if it is determined not so (NO in step S611), the CPU 202 advances the processing to step S613.

In step S612, in response to the print button 457 being touched, the CPU 202 transmits a print job to the target printer. Specifically, the CPU 202 generates a print job for issuing an instruction for printing an image which is being displayed for preview with the print settings indicated by the setting state 455. Then, the CPU 202 transmits the generated print job from the electronic apparatus 101 to the target printer (for example, the printing apparatus 104). The target printer (for example, the printing apparatus 104), which has received the print job, performs printing on a print medium (print paper) according to the received print job.

In step S613, the CPU 202 determines whether another operation has been performed in a state in which the print instruction screen 450 has been displayed. If it is determined that another operation has been performed (YES in step S613), the CPU 202 advances the processing to step S614, in which the CPU 202 then performs processing corresponding to the operation which has been performed. For example, in a case where the trimming icon 452 has been touched, the CPU 202 performs control to display a trimming screen, and performs trimming that is based on a trimming operation performed by the user. Moreover, in a case where the print settings button 456 has been touched, the CPU 202 displays the print settings screen and accepts a setting change operation concerning the print settings performed by the user.

In step S615, the CPU 202 determines whether the back button 491 has been touched.

If it is determined that the back button 491 has been touched (YES in step S615), the CPU 202 returns the processing to step S605, and, if it is determined not so (NO in step S615), the CPU 202 returns the processing to step S611.

In step S616, the CPU 202 determines whether an operation for issuing an instruction for additional registration of a printer has been performed. Issuing an instruction for additional registration of a printer can be performed by touching the tab icon 433. If it is determined that an operation for issuing an instruction for additional registration of a printer has been performed (YES in step S616), the CPU 202 advances the processing to step S620, and, if it is determined not so (NO in step S616), the CPU 202 advances the processing to step S617.

In step S617, the CPU 202 determines whether another operation has been performed in a state in which the home screen 400 has been displayed. If it is determined that another operation has been performed (YES in step S617), the CPU 202 advances the processing to step S618, and, if it is determined not so (NO in step S617), the CPU 202 advances the processing to step S619. In step S618, the CPU 202 performs processing corresponding to another operation. For example, in response to the function icon 421b for scanning being touched, the CPU 202 displays a scan settings screen and accepts a setting operation for scan settings (for example, paper targeted for scanning, the settings of color or monochrome, resolution, and storage location). Then, in response to a scan execution icon displayed in the screen being pressed, the CPU 202 transmits a scan job for performing scanning with the set scan settings to the target printer. Furthermore, in a screen in which the scan execution icon is displayed, the setting state of the above-mentioned scan settings is displayed, and the scan execution icon is displayed at the same position as the print button 457 illustrated in FIG. 4C. Moreover, the screen in which the scan execution icon is displayed is also displayed with E2E set to disabled. The reason for this is that the disadvantage of the navigation bar 490 being displayed in superimposition is significant, as with the print button 457. The target printer (for example, the printing apparatus 104), which has received the scan job transmitted in response to the scan execution icon being pressed, performs scanning of an original (reading of an original at a reading unit) according to the received scan job, and performs generation, storing, and transfer of an image obtained by scanning.

In step S619, the CPU 202 determines whether an operation for ending the print app 300 has been performed. If it is determined that an operation for ending the print app 300 (for example, a touch on the back button 491 in a state in which the home screen 400 has been displayed) has been performed (YES in step S619), the CPU 202 hides the screen which the print app 300 provides, and ends the processing illustrated in FIGS. 6A and 6B. If it is determined that an operation for ending the print app 300 has not been performed (NO in step S619), the CPU 202 returns the processing to step S602.

In step S620, the CPU 202 determines whether to perform a wireless setup for a printer (initial setting for wireless LAN communication in a printer). Upon proceeding to registration of a printer, first, the 202 makes a search as to whether there is a registrable printer on the network 103. In a case where, even if such a search is made, no registrable printer on the network 103 has been found and an instruction operation corresponding to performing wireless connection between the electronic apparatus 101 and a new printer has been received from the user, CPU 202 determines that a wireless setup for a printer is required (YES in step S620), and then advances the processing to step S622. In a case where a registrable printer on the network 103 has been found or an instruction for connection to a printer with other than wireless connection, such as wired connection (NO in step S620), the CPU 202 advances the processing to step S621, in which the CPU 202 performs additional registration of a printer with another method.

In step S622, the CPU 202 sets a wireless setup screen 460 as the display target screen, which is a screen to be displayed by the print app 300 (records such a screen on the RAM 204).

In step S623, the CPU 202 performs screen display processing on the screen set as the display target screen. The screen display processing is described below with reference to FIG. 7. In response to the processing operation in step S623, the wireless setup screen 460 is displayed.

FIG. 4E is a diagram illustrating a display example of the wireless setup screen 460, which is displayed on the display 214. The wireless setup screen 460 is a range indicated by a dashed line illustrated in FIG. 4E. In the wireless setup screen 460, a menu icon 461, a guide illustration 462, a “no” button 463, and a “yes” button 464 are displayed. A frame drawn by the dashed line in FIG. 4E is illustrated only for indicating the display region and is, therefore, not displayed in actuality. The status bar 480 and the navigation bar 490, which the OS provides, are not superimposed on the wireless setup screen 460. In other words, the display region of the wireless setup screen 460 is within the range of a display surface of the display 214 excluding the status bar 480 and the navigation bar 490. Since, as indicated in row 315 shown in FIG. 3B, E2E being set to disabled is defined in the layout file 5 corresponding to (defined in) the wireless setup screen 460, due to the processing illustrated in FIG. 7 described below, the wireless setup screen 460 is displayed with E2E being set to disabled.

In the wireless setup screen 460, the “yes” button 464 is displayed at the same position as the print button 457 displayed in the print instruction screen 450. Moreover, the “yes” button 464 is not allowed to be changed in position by a scrolling operation. The “yes” button 464 is an operation item for proceeding with wireless setup processing for a printer, so that, unless the “yes” button 464 is operated, the wireless setup for a printer is unable to be performed. If the wireless setup for a printer is not performed, it is impossible to transmit a print instruction to a printer via wireless communication. Thus, if the operability of the “yes” button 464, which is an operation item for establishing communication with a printer (printing apparatus) serving as an external device, decreases, this becomes a factor for the occurrence of a state in which it is impossible to issue an instruction for printing to the printing apparatus. Accordingly, in the print app 300 for transmitting an instruction to the external device, the disadvantage of the operability of the “yes” button 464, which is an operation item for establishing communication with the external device targeted for instruction, decreasing is significant. Accordingly, for the same reason as in the print instruction screen 450, in which the print button 457 is displayed, the wireless setup screen 460, in which the “yes” button 464 is displayed, is also displayed with E2E being set to disabled.

In step S624, the CPU 202 determines whether the “yes” button 464 has been touched.

If it is determined that the “yes” button 464 has been touched (YES in step S624), the CPU 202 advances the processing to step S625, and, if it is determined that an operation other than touching on the “yes” button 464 has been performed (NO in step S624), the CPU 202 returns the processing to step S621.

In step S625, the CPU 202 sets a wireless setup screen 470 as the display target screen, which is a screen to be displayed by the print app 300 (records such a screen on the RAM 204).

In step S626, the CPU 202 performs screen display processing on the screen set as the display target screen. The screen display processing is described below with reference to FIG. 7. In response to the processing operation in step S626, the wireless setup screen 470 is displayed.

FIG. 4F is a diagram illustrating a display example of the wireless setup screen 470, which is displayed on the display 214. The wireless setup screen 470 is a range indicated by a dashed line illustrated in FIG. 4F. In the wireless setup screen 470, a menu icon 471, a guide illustration 472, a checkbox 473, and a “next” button 474 are displayed. A frame drawn by the dashed line in FIG. 4F is illustrated only for indicating the display region and is, therefore, not displayed in actuality. The status bar 480 and the navigation bar 490, which the OS provides, are not superimposed on the wireless setup screen 470. In other words, the display region of the wireless setup screen 470 is within the range of a display surface of the display 214 excluding the status bar 480 and the navigation bar 490. Since, as indicated in row 316 shown in FIG. 3B, E2E being set to disabled is defined in the layout file 6 corresponding to (defined in) the wireless setup screen 470, due to the processing illustrated in FIG. 7 described below, the wireless setup screen 470 is displayed with E2E being set to disabled.

In the wireless setup screen 470, the “next” button 474 is displayed at a position fitting with the lower side of that screen as with the print button 457 displayed in the print instruction screen 450. Moreover, the “next” button 474 is not allowed to be changed in position by a scrolling operation. The “next” button 474 is an operation item for proceeding with wireless setup processing for a printer, so that, unless the “next” button 474 is operated, the wireless setup for a printer is unable to be performed. Accordingly, for the same reason as in the wireless setup screen 460, in which the “yes” button 464 is displayed, the wireless setup screen 470, in which the “next” button 474 is displayed, is also displayed with E2E being set to disabled.

In step S627, the CPU 202 determines whether the “next” button 474 has been touched.

If it is determined that the “next” button 474 has not been touched (NO in step S627), the CPU 202 does not advance the processing to a next step, and, if it is determined that the “next” button 474 has been touched (YES in step S627), the CPU 202 advances the processing to step S628.

In step S628, the CPU 202 performs wireless setup processing for a printer. Specifically, the CPU 202 searches for a beacon signal which a wireless access point incorporated in a printer (for example, the printing apparatus 104 which is not yet connected to the network 103) generates. Upon finding a beacon signal which a wireless access point incorporated in the printer targeted for setup generates, the CPU 202 interconnects the wireless access point incorporated in the printer targeted for setup and a wireless LAN. Then, the CPU 202 transmits, by wireless LAN communication, connection information (including a service set identifier (SSID)) about an AP of the wireless LAN terminal 102 to which the electronic apparatus 101 is connecting, to the printer targeted for setup. This causes the printer targeted for setup to connect to the wireless LAN terminal 102 and participate in the network 103. Then, by searching for the printer targeted for setup via the network 103 and connecting to the found printer, the CPU 202 completes the wireless setup of the printer targeted for setup and additionally registers the set-up printer with the print app 300.

Thus far is the description of application processing illustrated in FIGS. 6A and 6B.

FIG. 7 is a flowchart of screen display processing. This processing corresponds to the details of a processing operation in each of step S603, step S606, step S610, step S623, and step S626 illustrated in FIGS. 6A and 6B. This processing is implemented by the CPU 202 loading a program (more specifically, a program included in the code information 301) of the print app 300 recorded on the ROM 203 onto the RAM 204 and executing the program.

In step S701, the CPU 202 refers to a screen set as the display target screen recorded on the RAM 204. Then, the CPU 202 acquires, from the layout information group 302, a layout file corresponding to the screen set as the display target screen. For example, as illustrated in FIG. 3B, if the screen set as the display target screen is the home screen 400, the CPU 202 acquires a layout file 1, if the screen set as the display target screen is the file selection screen, the CPU 202 acquires a layout file 2, and, if the screen set as the display target screen is the print instruction screen, the CPU 202 acquires a layout file 3.

In step S702, the CPU 202 determines whether a definition for disabling E2E is currently recorded (described) in the layout file acquired in step S701. For example, as illustrated in FIG. 3B, if the acquired layout file is the layout file 1 corresponding to the home screen, a definition for disabling E2E is currently recorded. Moreover, for example, if the acquired layout file is the layout file 2 corresponding to the file selection screen, no definition for disabling E2E is currently recorded. Moreover, for example, if the acquired layout file is the layout file 3 corresponding to the print instruction screen, a definition for disabling E2E is currently recorded. If it is determined that a definition for disabling E2E is currently recorded in the acquired layout file (YES in step S702), the CPU 202 advances the processing to step S704, and, if it is determined not so (NO in step S702), the CPU 202 advances the processing to step S703.

In step S703, the CPU 202 sets a display region with E2E set to enabled as a region for displaying a screen which the print app 300 provides and which has been set as the display target screen. The display region with E2E set to enabled is a range including a region on which the status bar 480 and the navigation bar 490 are superimposed and is broader than a display region with E2E set to disabled. For example, the display region of the file selection screen 440 illustrated in FIG. 4B is the display region with E2E set to enabled.

In step S704, the CPU 202 sets a display region with E2E set to disabled as a region for displaying a screen which the print app 300 provides and which has been set as the display target screen. The display region with E2E set to disabled is a range excluding a region in which the status bar 480 and the navigation bar 490 are displayed and is narrower than a display region with E2E set to enabled. For example, the display region of each of the print instruction screen 450 illustrated in FIG. 4C, the wireless setup screen 460 illustrated in FIG. 4E, and the wireless setup screen 470 illustrated in FIG. 4F is the display region with E2E set to disabled.

In step S705, the CPU 202 acquires other information about the display target screen. For example, the CPU 202 acquires, from the layout file acquired in step S701, information about, for example, arrangement locations. Moreover, the CPU 202 acquires, from the resource information 303, content to be displayed in the display target screen.

In step S706, based on the information acquired in step S705, the CPU 202 performs displaying (drawing) of the display target screen on the display region set in step S703 or step S704. Furthermore, in a case where the display region with E2E set to enabled has been set in step S703, the status bar 480 and the navigation bar 490 are displayed in a semi-transmissive manner in superimposition on the display target screen. However, since the OS performs processing for superimposition display in a semi-transmissive manner of the status bar 480 and the navigation bar 490, the display control processing which the print app 300 performs is until the processing operation in step S706.

Thus far is the description of the screen display processing illustrated in FIG. 7.

As described above, according to the present embodiment, even in a case where a print instruction icon for providing an important function in the print app 300, which issues an instruction for printing to a printing apparatus, is operated by the OS with E2E set to enabled by default, it is possible to display the print instruction icon in a position good for the operability thereof while preventing or reducing a decrease in operability thereof.

In the present embodiment, the print instruction icon is the print button 457. The print instruction icon (the print button 457) is displayed, based on a lower side serving as a lower end side of the display range of the print instruction screen 450 which the print app 300 provides, in a position adjacent to the lower side or with a predetermined margin set from the lower side.

E2E is a function in which a function icon which is displayed in a screen region which is displayed in an end region of the screen and which the OS provides becomes transmissive and an app screen is also displayed at the back side of an end region adjacent to at least one end of the display 214 including the back side of the function icon. In the example described in the above-described embodiment, the screen region which the OS provides corresponds to the status bar 480 and the navigation bar 490. In the example of the navigation bar 490, the function icon which is displayed in a screen region which the OS provides corresponds to the back button 491, the home button 492, and the task button 493. In the example of the navigation bar 490, the one end of the display 214 corresponds to the lower end thereof.

Moreover, according to the present embodiment, even in a case where an operation icon for performing the wireless setup of an external device in the print app 300 is operated by the OS with E2E set to enabled by default, it is possible to display the operation icon in a position good for the operability thereof while preventing or reducing a decrease in operability thereof. Since the print app 300 is an app for issuing an operation instruction to a printing apparatus serving as an external device, the operation icon for performing the wireless setup of the external device is an important operation icon. In the present embodiment, the operation icon for performing the wireless setup corresponds to the “yes” button 464 and the “next” button 474. The operation icon for performing the wireless setup of the external device (the “yes” button 464 or the “next” button 474) is displayed, based on a lower side of the display range of a screen which the print app 300 provides, in a position adjacent to the lower side or with a predetermined margin set from the lower side.

In Android™ 15 or Android™ higher than Android™ 15, which is an OS with E2E set to enabled by default described in the present embodiment, in addition to E2E being set to enabled by default, the following control is performed by the OS.

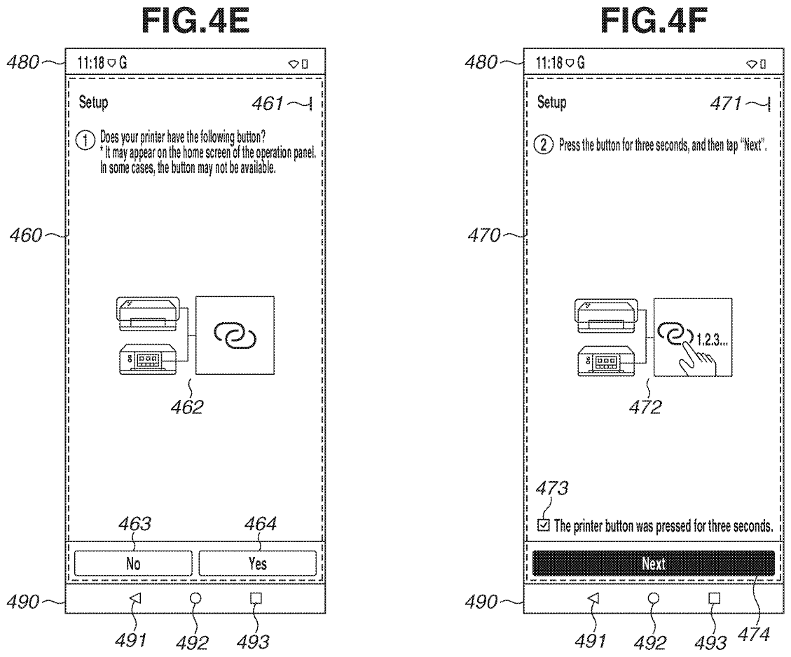

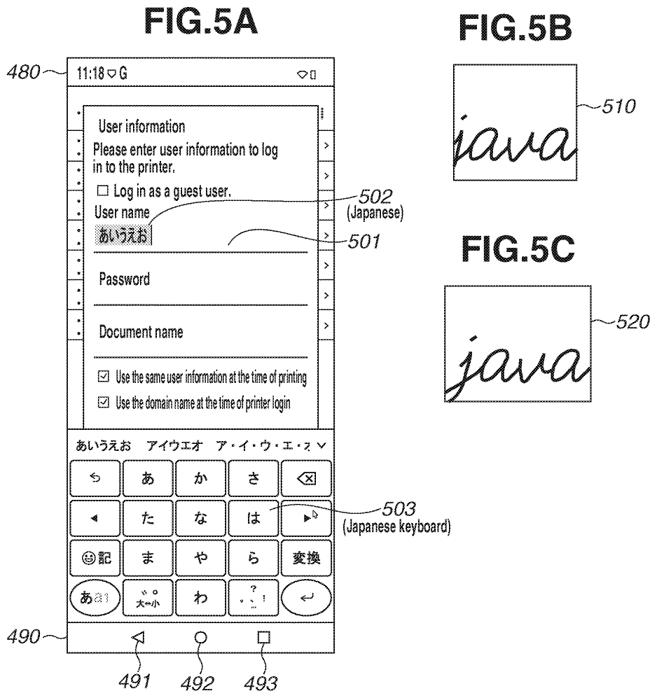

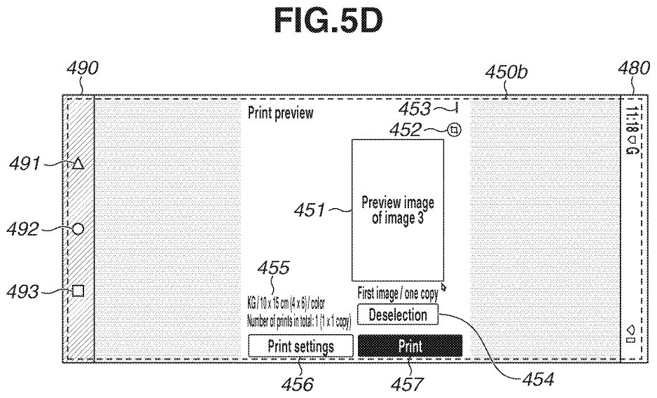

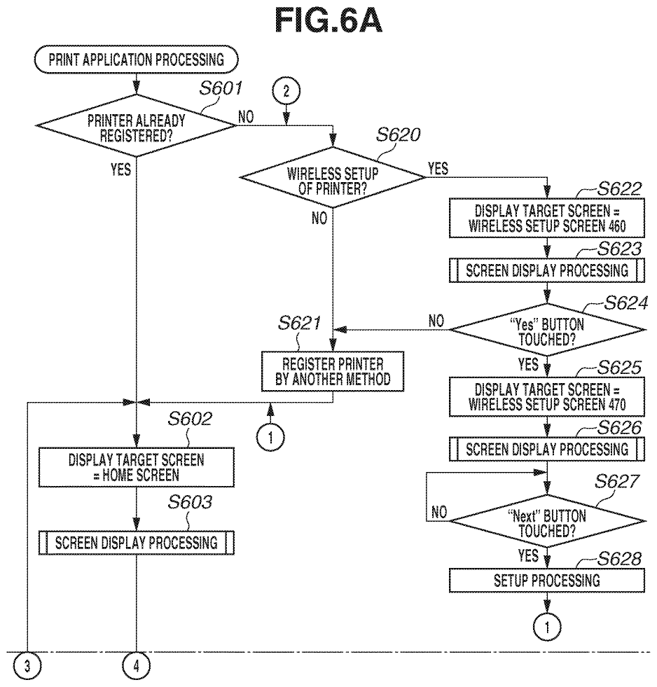

The height of the minimum row (i.e., one row) of an EditText element (a display element in which input text is displayed) differs depending on at least one of the setting of a display language and the reference font of a designated locale. FIG. 5A illustrates a display example of an EditText element in a screen which is provided by the print app 300. Specifically, FIG. 5A illustrates a display example of a screen for accepting inputting of user information for logging in to the target printer, which is provided by the print app 300. In a text region 501, text which has been input with a software keyboard 503 is displayed. In the example illustrated in FIG. 5A, text which has been input in Japanese to the text region 501 is displayed as an EditText element 502. The height of the EditText element 502 differs depending on whether the input language is English, Japanese, or Burmese, so that the EditText element 502 is higher in Japanese than in English and is higher in Burmese than in Japanese.

Moreover, in the case of an intricate font or language (for example, cursive writing or Thai), the width of TextView expands to prevent cut-offs. Moreover, a padding located on the more left side can be added by flag specification. FIG. 5B illustrates a standard layout 510 in a case where English text is displayed with a cursive writing font. While text “java” in English is displayed with cursive writing, part of a character (the left side portion of “j”) is missing (cut off). FIG. 5C illustrates a layout 520 obtained by adding a width and a padding to display the cursive writing of “java” in English. In the layout 520, the cursive writing of “java” in English is displayed without the left side portion of “j” missing. With regard to the OS with E2E set to enabled by default in the present embodiment, it is possible to perform displaying such as that of the layout 520.

FIG. 5D illustrates a display example in a case where the print instruction screen of the print app 300 has been displayed in a landscape layout. If, in the state in which the print instruction screen 450 illustrated in FIG. 4C has been displayed and in the state in which the auto-rotate of the OS has been turned on, the orientation of the electronic apparatus 101 is changed from a portrait orientation to a landscape orientation, a print instruction screen 450b illustrated in FIG. 5D is displayed. The print instruction screen 450 and the print instruction screen 450b are screens having the respective same corresponding functions but differ in the display orientation of characters and in the layout. The portrait orientation is a direction (orientation) in which the vertical direction (longitudinal direction) of the display 214 is parallel to the direction of gravitational force, and the landscape orientation is a direction (orientation) in which the horizontal direction (widthwise direction) of the display 214 is parallel to the direction of gravitational force. Whether the electronic apparatus 101 is in the portrait orientation or the landscape orientation is detected by an orientation detection sensor (for example, an acceleration sensor) incorporated in the electronic apparatus 101, and switching is performed between the print instruction screen 450 and the print instruction screen 450b according to a result of detection performed by the orientation detection sensor.

The print instruction screen 450b is a screen corresponding to the print instruction screen (landscape) shown in row 314 in FIG. 3B, and is a screen the layout of which is defined by the layout file 4. Since E2E is undefined in the layout file 4, the print instruction screen 450b is displayed with E2E set to enabled, and is thus displayed with use of a range including the status bar 480 and the navigation bar 490.

In the print instruction screen 450b, the print button 457 is displayed, based on a lower side in a case where the display 214 has been set to the landscape orientation (the lower side in FIG. 5D), in a position with a predetermined margin set from the lower side. Thus, the print button 457 is displayed at the lower portion of the print instruction screen 450b in a case where the display 214 has been set to the landscape orientation. However, in a case where the display 214 has been set to the landscape orientation, the status bar 480 and the navigation bar 490 are displayed not at the lower portion of the print instruction screen 450b in a case where the display 214 has been set to the landscape orientation but at the left side portion and right side portion of the print instruction screen 450b, respectively. Therefore, the print button 457 is unlikely to be superimposed on the status bar 480 and the navigation bar 490 which the OS provides, the possibility of the operability of the print button 457 decreasing is low. Therefore, the print instruction screen 450b is displayed without E2E being set to disabled, so that the advantage of E2E is enjoyed and displaying is performed with use of a larger area. Furthermore, the left side portion of the display 214 illustrated in FIG. 5D (the left side portion obtained when the display 214 is in the landscape orientation) is the same side portion as the lower side portion of the display 214 illustrated in FIG. 4C (the lower side portion obtained when the display 214 is in the portrait orientation). In this way, in a case where, when the screen with E2E set to disabled is being displayed, the positional relationship between the portrait and landscape orientations of the display 214 has been changed (from the portrait orientation to the landscape orientation or from the landscape orientation to the portrait orientation), E2E is set to enabled (disabling of E2E is cancelled). On the other hand, in a case where, when the screen with E2E set to enabled is being displayed, the positional relationship between the portrait and landscape orientations of the display 214 has been changed (from the portrait orientation to the landscape orientation or from the landscape orientation to the portrait orientation), E2E can be set to disabled. Thus, in response to the orientation of the electronic apparatus 101 having changed from one orientation to the other orientation between a first orientation in which the display 214 is in the portrait orientation and a second orientation in which the display 214 is in the landscape orientation, a screen differing in the direction of displaying is displayed. In addition, control is performed in such a way as to cause a change from a state in which E2E has been disabled to a state in which E2E is not disabled.

Furthermore, while, in the above-described embodiment, an example in which whether to set E2E to disabled differs for each screen which the print app 300 provides has been described, a configuration in which, with regard to all of the screens which the print app 300 provides, E2E is equally set to disabled can be employed. In this case, a description for defining setting E2E to disabled is made with respect to all of the layout files corresponding to the respective screens which the print app 300.

Furthermore, the above-mentioned various control operations, which have been described as the ones which the CPU 202 performs, can be performed by one piece of hardware or can be performed by a plurality of pieces of hardware (for example, a plurality of processors or circuits) sharing the respective processing operations to control the entire apparatus.

Moreover, while the present technique has been described above in detail based on some embodiments, the present technique is not limited to such specific embodiments and can also be applied to various aspects without departing from the gist of the present technique. Additionally, the above-described embodiments merely represent an embodiment of the present technique, and some or all of the embodiments can be combined as appropriate.

Moreover, while, in the above-described embodiments, a case where the present technique is applied to the electronic apparatus 101 has been described as an example, the present technique is not limited to this example, and can also be applied to an electronic apparatus capable of customizing (adding or deleting by a user operation) an item to be displayed. The present technique can be applied to, for example, a personal computer, a tablet terminal, a mobile phone terminal, a portable image viewer, a printer apparatus equipped with a display, a digital photo frame, a music player, a gaming machine, an electronic book reader, and home electric appliances.

Moreover, while, in the above-described embodiments, a case where the present disclosure is applied to a print app for instructing a printer to execute a job (i.e., for controlling a printer serving as an external device) has been described as an example, the present disclosure is not limited to the print app. Thus, the present disclosure can also be applied to other applications. For example, the present disclosure can also be applied to a control application for external equipment such as an air conditioner control application, which runs on, for example, a smartphone, for transmitting various operation instructions to an air conditioner serving as external equipment. The present disclosure does not apply only to an air conditioner but can also be applied to an application for controlling home electrical appliance serving as external equipment such as a television set, a vacuum cleaner, and lighting equipment. Moreover, the present disclosure does not apply only to home electrical appliance but can also be applied to an application for controlling an Internet of Things (IoT) device such as a smart speaker.

According to the present disclosure, it is possible to effectively prevent or reduce the operability of an operation item which application software provides from decreasing due to displaying of a display element which an operating system (OS) provides.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050807 filed Mar. 25, 2025, which is hereby incorporated by reference herein in its entirety.

What is claimed is:

1. A non-transitory computer-readable storage medium storing one or more programs that, when executed by one or more computers operating under an operating system (OS) in which a specific function is enabled by default, the specific function causing a specific display element provided by the OS to be displayed in an end region of a display unit in a semi-transmissive manner and causing a screen provided by an application software to be displayed in an area including the end region of the display unit, cause the one or more computers to perform operations comprising:
displaying, on the display unit, a print instruction screen provided by specific application software, the print instruction screen including, on a side of the end region, an operation item configured to accept a print instruction;
transmitting, to a printing apparatus serving as an external device, a print job based on a touch operation performed on the operation item; and
disabling the specific function of the OS such that the print instruction screen is displayed with the specific function disabled.

2. The non-transitory computer-readable storage medium according to claim 1, wherein, in a case where the specific function of the operating system is disabled, the program further causes the one or more computers to display a screen provided by the application software within a range of the display unit that excludes a region in which the specific display element is displayed.

3. The non-transitory computer-readable storage medium according to claim 1, wherein the specific display element includes one or more function icons provided by the OS.

4. The non-transitory computer-readable storage medium according to claim 3, wherein the specific display element includes a back button and a home button configured to accept an instruction to display a home screen in which activation icons for a plurality of pieces of application software are displayed.

5. The non-transitory computer-readable storage medium according to claim 1, wherein the end region is a region adjacent to a lower side of the display unit when a longitudinal direction of the display unit is parallel to a direction of gravitational force.

6. The non-transitory computer-readable storage medium according to claim 1, wherein the operation item is fixed in position and is not movable by a scrolling operation.

7. The non-transitory computer-readable storage medium according to claim 1, wherein disabling the specific function when displaying the print instruction screen is performed by referring to a layout file included in the specific application software, the layout file defining that the specific function is to be disabled for the print instruction screen.

8. The non-transitory computer-readable storage medium according to claim 7, wherein, in the layout file, the operation item is set to be displayed with a margin from a lower side of a display region of the print instruction screen, the margin being smaller than a height of the end region set from the lower side.

9. The non-transitory computer-readable storage medium according to claim 1, wherein the print instruction screen displays at least one of a print setting including at least one of print paper size, a color or monochrome setting, and a number of prints, and a print preview image.

10. The non-transitory computer-readable storage medium according to claim 1, wherein the application software is a print app configured to issue a print instruction to the printing apparatus.

11. The non-transitory computer-readable storage medium according to claim 1, wherein the specific function is Edge-to-Edge.

12. The non-transitory computer-readable storage medium according to claim 1, wherein the OS is Android™ higher than or equal to Android™ 15.

13. The non-transitory computer-readable storage medium according to claim 1, wherein a height of a minimum row of an EditText element which is displayed based on control of the OS differs depending on at least one of a display language setting and a reference font of a designated locale.

14. The non-transitory computer-readable storage medium according to claim 1, wherein, based on control of the OS, a TextView obtained by adding a width and a padding in such a manner that part of a character to be displayed is not missing is displayed.

15. The non-transitory computer-readable storage medium according to claim 1,
wherein the one or more programs further cause the one or more computers to:
display, on the screen provided by the specific application software, a specific screen in which, on a side of the end region, a specific item which is required to be operated to perform a setup of wireless local area network (LAN) communication in the printing apparatus is arranged; and
perform processing for setting up of wireless local area network (LAN) communication in the printing apparatus based on a touch operation performed on the specific item, and
wherein disabling of the specific function when displaying the specific screen is performed based on a layout file included in the specific application software, the layout file defining that the specific function is to be disabled for the specific screen.

16. The non-transitory computer-readable storage medium according to claim 15, wherein the setup includes transmitting a service set identifier of an access point to be connected from an electronic apparatus including the oner or more computers to the printing apparatus.

17. The non-transitory computer-readable storage medium according to claim 1,
wherein the one or more programs further cause the one or more computers to display a selection screen which is able to be scrolled according to a scrolling operation for a plurality of options, and
wherein the specific function is not disabled when the selection screen is displayed.

18. The non-transitory computer-readable storage medium according to claim 1,
wherein the one or more programs further cause the one or more computers to display the screen whose display orientation changes in response to a change in orientation of an electronic apparatus including the one or more computers, the orientation change being between a first orientation in which a longitudinal direction of a display surface is parallel to a direction of gravitational force, and a second orientation in which a widthwise direction of the display surface is parallel to the direction of gravitational force, and
wherein, in response to the change in orientation between the first orientation and the second orientation, the specific function is switched from a disabled state to a non-disabled state.

19. The non-transitory computer-readable storage medium according to claim 18, wherein, when the specific function is disabled and the print instruction screen is displayed, and in response to the orientation of the electronic apparatus changing from the first orientation to the second orientation, disabling of the specific function is canceled.

20. A non-transitory computer-readable storage medium storing one or more programs that, when executed by one or more computers operating under an operating system (OS) in which a specific function is enabled by default, the specific function causing a specific display element provided by the OS to be displayed in an end region of a display unit in a semi-transmissive manner and causing a screen provided by an application software to be displayed in an area including the end region of the display unit, cause the one or more computers to perform operations comprising:
displaying, on the display unit, a specific screen including, on a side of the end region, a specific item for performing a setup of wireless local area network (LAN) communication in external equipment;
perform processing for executing the setup of wireless LAN communication in the external equipment; and
disabling the specific function of the OS such that the specific screen is displayed with the specific function disabled.

21. The non-transitory computer-readable storage medium according to claim 20, wherein the setup includes transmitting a service set identifier of an access point to be connected from an electronic apparatus including the one or more computers to the external equipment.

22. A control method executed by one or more computers operating under an operating system (OS) having a specific function enabled by default, the specific function causing a display element provided by the OS to be displayed in an end region of a display unit in a semi-transmissive manner and causing a screen provided by an application software to be displayed in an area including the end region of the display unit, the control method comprising:
displaying, on the display unit, a print instruction screen including, on a side of the end region, an operation item for accepting a print instruction;
transmitting a print job to a printing apparatus serving as an external device based on a touch operation performed on the operation item; and
disabling the specific function of the OS such that the print instruction screen is displayed with the specific function disabled.

23. A control method executed by one or more computers operating under an operating system (OS) having a specific function enabled by default, the specific function causing a display element provided by the OS to be displayed in an end region of a display unit in a semi-transmissive manner and causing a screen provided by an application software to be displayed in an area including the end region of the display unit, the control method comprising:
displaying, on the display unit, a specific screen provided by the application software, the screen including, on a side of the end region, an item operable by a user to perform a setup of wireless local area network (LAN) communication in external equipment;
performing processing for executing the setup of wireless LAN communication in the external equipment; and
disable the specific function of the OS such that the specific screen is displayed with the specific function disabled.

24. An electronic apparatus controlled by an operating system (OS) that provides a default function being configured to display a display element provided by the OS in an end region of a display unit in a semi-transmissive manner and causing a screen provided by an application software to be displayed in an area including the end region of the display unit, the electronic apparatus comprising:
at least one memory and at least one processor which function as:
a display control unit configured to control display, on the display unit, a print instruction screen provided by an application software, the print instruction screen including, on a side of the end region, an operation item for receiving a print instruction;
a transmission unit configured to transmit a print job to a printing apparatus serving as an external device based on a touch operation performed on the operation item; and
a control unit configured to perform control to disable the specific function such that the print instruction screen is displayed with the specific function disabled.

25. An electronic apparatus controlled by an operating system (OS) that provides a default function being configured to display a display element provided by the OS in an end region of a display unit in a semi-transmissive manner and causing a screen provided by an application software, a print instruction screen including the end region of the display unit is enabled by default, the electronic apparatus comprising:
at least one memory and at least one processor which function as:
a display control unit configured to control display, on the display unit, a specific screen including, on a side of the end region, a specific item for performing a setup of wireless local area network (LAN) communication in external equipment;
a processing unit configured to perform processing for performing the setup of wireless LAN communication in the external equipment; and
a control unit configured to perform control to disable the specific function such that the specific screen is displayed with the specific function disabled.
